(19) United States
(12) Patent Application Publication
(10) Pub. No.: US 2016/0076999 A1
(43) Pub. Date: Mar. 17, 2016

(54) REFRACTIVE INDEX BASED MEASUREMENTS

(71) Applicant: TECHNICAL UNIVERSITY OF DENMARK, Kgs. Lyngby (DK)

(72) Inventors: Henrik Schiøtt SØRENSEN, Ølstykke (DK); Thornas Martini JØRGENSEN, Jyllinge (DK)

(21) Appl. No.: 14/888,372

(22) PCT Filed: Mar. 18, 2014
(86) PCT No.: PCT/EP2014/055437

§ 371 Date: Oct. 30, 2015

(30) Foreign Application Priority Data
Mar. 21, 2013 (EP) 13160344.1

(51) Int. Cl. G01N 21/45; G01N 21/85

(52) U.S. Cl. CPC G01N 21/45; G01N 21/85; G01N 2201/06113

(57) ABSTRACT

A refractive index based measurement of a property of a fluid is measured in an apparatus including a variable wavelength coherent light source, a sample chamber, a wavelength controller, a light sensor, a data recorder and a computation apparatus, by—directing coherent light having a wavelength along an input light path, —producing scattering of the light from each of a plurality of interfaces within the apparatus including interfaces between the fluid and a surface bounding the fluid, the scattering producing an interference pattern formed by the scattered light, —cyclically varying the wavelength of the light in the input light path over a 1 nm to 20 nm wide range of wavelengths a rate of from 10 Hz to 50 KHz, —recording variation of intensity of the interfering light with change in wavelength of the light at an angle of observation, and—calculating the property from the variation.

The present invention relates to methods and apparatus for making refractive index (RI) based measurements on a fluid by interferometry.

U.S. Pat. No. 4,188,123 discloses a method of optically measuring the concentration of carriers in a doped region of a semi-conductor wafer, which is of course solid. Periodically spaced doped strips form a diffraction grating at the surface of the solid. Measurement of the angle at which a first order diffraction is observed gives information regarding the dopant concentration at a given depth which is wavelength dependent. Repeating the measurement using different interrogating wavelengths can produce a concentration depth profile. However, changing the wavelength will change the angle at which the first order diffraction can be observed. Given the need to form a diffraction grating on the surface to be observed, it would seem apparent that this method simply cannot be applied to a fluid.

WO2004/023115 and US2006/0012800 disclosed a method of determination of refractive index using micro interferometric back scatter detection (MIBD) also known as back scatter interferometry (BSI) in which light from a laser was directed onto a capillary tube containing a sample liquid and the angular dependence of interference fringes produced by back scattering from the several optical interfaces involved was analysed. In particular, a critical angle was observed at which total internal reflection within the capillary wall caused the intensity of the fringes to drop sharply. An absolute value for the refractive index could be determined.

US 2002/0135772 and Bornhop et al; Science 21 Sep. 2007; Vol. 317 describe a method of conducting MIBD using a laser beam directed onto a rectangular cross section channel in a microfluidic chip. Interference fringes were produced which had a position which was dependent on the refractive index of the liquid in the channel, and changes in the refractive index (e.g. upon chemical binding) were seen as a shift in the fringe pattern, so providing a relative measure of the refractive index. Thus, changes in refractive index in the sample can be monitored by observing the movement of fringes in the pattern over time.

Whilst the above disclosures relate to obtaining refractive index based information from interference fringes produced by backscattered light, U.S. Pat. No. 5,251,009 describes a related method in which forward scattered light produces the interference. Laser light is directed onto a fluid filled capillary and scattering occurs at interfaces formed by the capillary and its contents. A detector is provided off the axis of the laser beam, but on the other side of the capillary from the laser to view forward scattered light. Because there will be contributions from the exterior of the capillary acting as an interface which are considered an undesirable complicating factor in the interference pattern, steps are described for subduing such contributions. These involve enclosing the capillary in a fluid filled rectangular box and matching the refractive index of the fluid in the box with that of the glass or other material of the capillary wall. It was desired that the only interfaces contributing to the interference pattern would be those between the interior wall surface of the capillary and its contents.

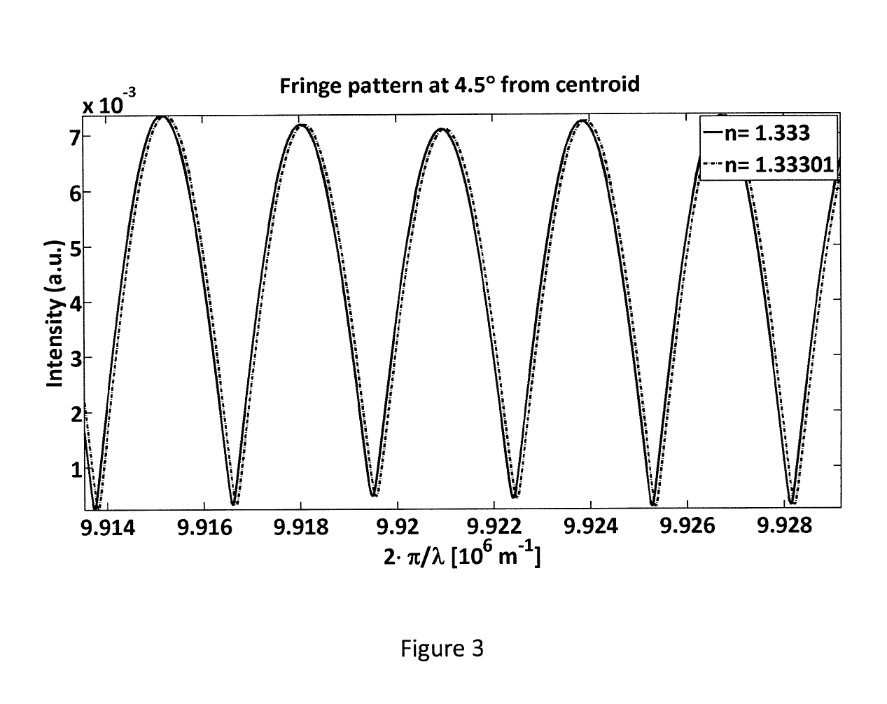

As is seen in FIG. 3 of US2006/0012800, the spacing between the dark and light fringes of the interference pattern produced by BSI is not uniform but changes with distance from the centre of the pattern, i.e. the spatial frequency of the fringe pattern is chirped. The same will apply to fringe patterns generated by forward scattering of the kind dealt with in U.S. Pat. No. 5,251,009.

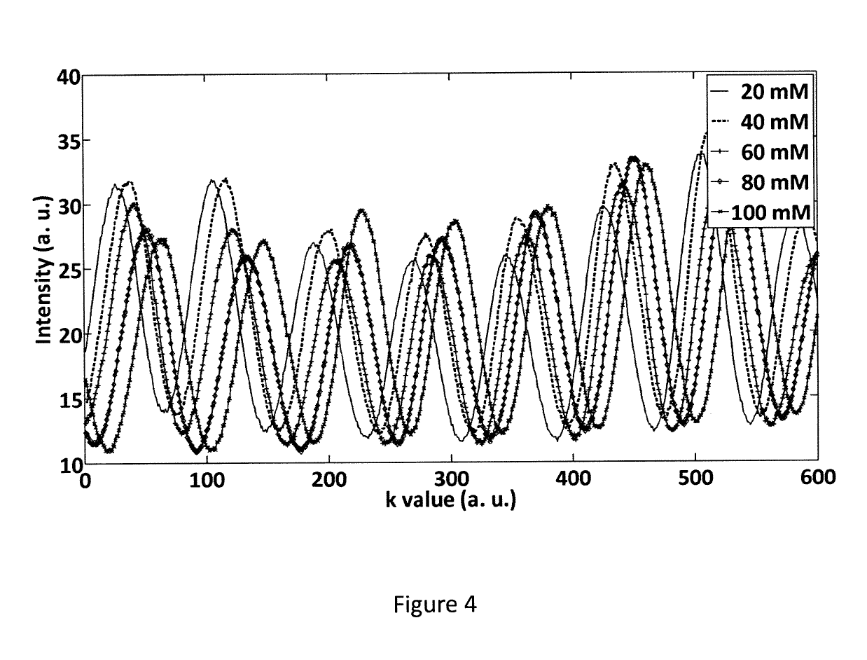

As one moves away from the angle of illumination, the fringes become closer together. The rate of change of spacing with angular distance however falls as one moves to greater angles, so the pattern of brightness/intensity becomes more sinusoidal. As seen in FIG. 4 of US2006/0012800 there is a good deal of fine intensity structure within these medium frequency fringes. When the refractive index of the sample changes, the position of each fringe shifts. A consequence of the spatial chirping of these fringes is that when the refractive index changes and the fringes move, they do not all move at a uniform speed. This is noted by S. S. Dotson in a Dissertation submitted to Vanderbilt University in 2008.

Dotson discloses that if a linear CCD array and a fast Fourier transform (FFT) are used to acquire a fringe pattern, one can determine the positional shift with change in RI. Selecting a slice of pixels from a region of the pattern where the fringe pattern is approximately sinusoidal is necessary because the method is dependent on a constant frequency over the angular region being used. A detection limit of 7×10⁻⁸ RI units (RIU) is said to be possible. Dotson also teaches the use of a cross-correlation technique as an alternative to FFT for analysing the fringe pattern as a means of avoiding being limited to an apparently sinusoidal region of the pattern. Dotson remarks that the fringes in the more sinusoidal area of the pattern do not move so much with changes in RI as fringes nearer the centre of the pattern and this limits the sensitivity.

We have now found that if instead of observing over a range of output angles the spatial positions of fringes produced using a single wavelength of input light, one instead observes how the intensity of light at a chosen angle of observation varies when the wavelength of the input light is varied, it is possible to observe a more sinusoidal variation and to avoid the complications in data analysis resulting from the above mentioned spatial chirp. Furthermore, the sensitivity of the system can be increased. Also, because one can make observations at a single point, the apparatus may be made more compact and alignment of the components thereof may be made simpler.

Accordingly, the present invention now provides a method of refractive index based measurement of a property of a fluid comprising

directing coherent light having a wavelength along an input light path within an apparatus,

producing scattering of said light from each of a plurality of interfaces within said apparatus including interfaces between said fluid and a surface bounding said fluid, said scattering producing an interference pattern formed by said scattered light,

varying the wavelength of said light in said input light path,

recording variation of intensity of the interfering light with change in wavelength of the light at an angle of observation, and

calculating a said property from said variation.

Suitably the light may be in the visible or infrared part of the spectrum.

One aspect of how this differs from the method of U.S. Pat. No. 4,188,123 is of course that here the angle of observation remains constant as the wavelength changes. Also, of course, the origin of the diffraction pattern is wholly different.

Preferably, said varying of the wavelength of said light sweeps the wavelength of the light over a range of wavelengths, which range is from 1 nm to 20 nm wide.

The varying of the wavelength of the light is preferably repeated cyclically.

Suitably, said varying of the wavelength of said light sweeps the wavelength of the light cyclically at a rate of from 10 Hz to 50 KHz.

The invention may be performed using a tuneable laser source (TLS) providing a laser whose output wavelength can be swept (to provide wavelengths on a continuous or random access basis) over a certain, and wavelength range. Such a source may be tuneable over typically 50-150 nm, e.g. 85 nm. However, such a wide range is not necessary for the practice of this invention. TLS's are frequently used in various measurement applications where a recording of a certain measure versus wavelength or wavenumber is performed. Parameters generally characterizing a TLS include single-mode operation, mode-hop-free tuning over as wide a range as possible, narrow linewidth, low optical-frequency noise, and quick tuning rate. Optical power requirements are often modest, but power stability, low relative-intensity noise, and high side-mode-suppression ratios are helpful. Small size, low power consumption and shock/vibration tolerance are crucial for portable field-use instrumentation. Performance must typically be traded for small size and low power consumption, since shorter cavity lengths can lead to a higher quantum-limited optical-frequency-noise floor and high-speed drive electronics are generally less power efficient. The most important factor in determining end-system performance using the TLS is the ability to know the laser wavelength as a function of time with very high precision.

The technological implementation of tunable semiconductor lasers mainly falls into three categories, namely the:
External Cavity Laser (ECL)
Edge-emitting Distributed Bragg Reflector (DBR) laser.
VCSEL.

Tunable external cavity lasers are widely used as they offer great flexibility, exploit the full gain spectrum of the Semiconductor Optical Amplifier (SOA) and can make use of multiple optical components for wavelength selective feedback. The majority of widely tuneable ECLs are either of the Littrow, Littmann-Metcalf or Fabry-Perot configuration. The advantage of the ECL is that high single-mode output powers can be achieved together with a wide tuning range, only limited by the gain medium. In both the Littrow and Littman-Metcalf configuration a diffraction grating is used as the wavelength selective feedback to the SOA. In the Fabry-Perot configuration a Fabry-Perot filter is used for wavelength selection, suppressing all other nearby wavelengths. Wide and rapid tuning can be achieved by Micro-Electro-Mechanical Systems (MEMS) Fabry-Perot filters. Tunable edge-emitting DBR lasers were originally developed to target telecommunications. For Sampled Grating DBR (SGDBR) wavelength tuning is achieved by tuning the reflection spectrum of the two cavity mirrors to coincide while tuning a phase section to match the propagation phase. Wide discontinuous wavelength tuning can be achieved with the added benefit that a SOA can be monolithically integrated to boost the power output.

The vertical-cavity surface-emitting laser, or VCSEL is a type of semiconductor laser diode with laser beam emission perpendicular from the top surface, contrary to conventional edge-emitting semiconductor lasers (also in-plane lasers) which emit from surfaces formed by cleaving the individual chip out of a wafer. In a tuneable VCSEL, the Fabry-Perot cavity length is directly modulated by moving one of the two mirror stacks.

Tuneable external-cavity diode lasers represent a type of TLS than can meet the requirements for the present application, and the most popular and successful version of this laser type is the Littman-Metcalf cavity. This design uses a wideband optical-gain chip and a pivoting dispersion-grating/external-mirror pair to tune the selected cavity wavelength. Popular tuning mechanisms include but are not limited to servo motors, magnetically actuated voice coils, and electrostatic micro-electromechanical systems (MEMS) motors.

These Littman-Metcalf external-cavity tuneable lasers typically exhibit moderate power and excellent mode-hope-free tuning range, with good linewidth and low noise. However, in some cases component size limits tuning speed and ruggedness. A good example is the voice-coil tuning mechanism: because the tuning rate is proportional to the integral of the drive current and a relatively large magnet mass can build significant inertia, this actuator is capable of very smooth tuning with very low optical-frequency noise. But the same properties that lower noise also tend to make the design hard to miniaturize, relatively slow, and difficult to protect against sudden external acceleration.

At the other size extreme, using an electrostatic MEMS motor to tune the mirror-grating coupling angle gives the laser potential for fast scans (up to the motor resonance) and can allow the laser to fit in a very small package that is more easily isolated from shock and vibration—key advantages when considering source candidates for portable applications and in high-vibration environments.

The most important factor in determining end-system performance in scanning laser interferometry and spectroscopy is the ability to know the laser wavelength as a function of time with very high precision. The advantages of a compact Littman-Metcalf laser design in this regard can be greatly enhanced when combined with advanced low-noise laser control driver circuitry

Wavelength-tuning linearity is another important aspect for a suitable TLS. The linearity can be measured by scanning a Michelson interferometer with the laser and observing the interference fringes with a photodiode and oscilloscope. The Fourier transform of these data sets indicates a great deal about the tuning “smoothness” of these lasers: the narrower the transform peak the better the tuning linearity and the lower the optical frequency noise.

If the tuning is not linear a driver-wavelength-monitor signal (obtained for instance by scanning a Michelson Interferometer with the TLS) can be used to greatly enhance the sharpness of the Fourier-transform peak; by using it to resample the fringe data in true equal optical-frequency steps, the fringe data produces a transform-limited peak.

A suitable source may be based on an external cavity laser geometry with a Cat-Eye wavelength selection device. Such an external cavity laser may comprise a single gain element where one facet of the element serves as an end mirror for the cavity. The extended cavity may comprise one or more collimating lenses and a Cat-Eye wavelength selection device. The intra-cavity side of the semiconductor gain element may be anti-reflection coated, providing a residual reflectivity of less than 10⁻⁴ thus allowing for the efficient formation of an extended cavity.

Wavelength selection may be achieved using a diffraction grating mounted onto a scanner such as a resonant galvanometer with a focusing lens, mirror, and slit assembly providing active wavelength selection. The focusing lens and slit/mirror assembly are separated by the focal length of the lens. This configuration is commonly referred to as a Cat-Eye and is highly insensitive to angular misalignment.

Output from the laser cavity may be coupled into a fibre using a lens system containing an isolator that prevents optical feedback into the cavity. This design enables a robust alignment due to the Cat-Eye configuration of the back-reflector. An alternative is to use a quasi-collimated beam on the laser cavity back-reflector.

At fast frequency sweep speeds, the laser frequency varies sinusoidally in time. Such a laser may include a built-in Mach-Zehnder Interferometer (MZI) with balanced detector output, which can be used as a frequency clock because the zero crossings of the interference fringe signal are equally spaced in optical frequency (k-space).

By way of example, such a laser source may sweep across at least 100 nm at a 16 kHz repetition rate, offer a coherence length of 6 mm, and deliver more than 10 mW of average optical power out of an single mode fibre.

The invention includes apparatus for refractive index based measurement of a property of a fluid, said apparatus comprising a variable wavelength coherent light source, a sample chamber, a wavelength controller, a light sensor, a data recorder and a computation apparatus, wherein

the variable wavelength light source is arranged for directing coherent light having a wavelength along an input light path within the apparatus,

the sample chamber is arranged in the input light path for holding a fluid sample and for producing scattering in use of said light from each of a plurality of interfaces within said sample chamber including interfaces between said fluid and a surface bounding said fluid, said scattering producing an interference pattern formed by said scattered light,

the wavelength controller is operable for varying the wavelength of said light in said input light path,

the light sensor is positioned and operatively connected to the data recorder for sensing and recording variation of intensity of the interfering light with change in wavelength of the light at an angle of observation, and

the computation apparatus is programmed for calculating a said property from said variation.

Preferably, the said cavity containing said fluid has a transverse dimension in the direction of the input light path of from 1 μm to 10 mm, optionally from 0.5 mm to 3 mm, more preferably from 1 to 2 mm.

The apparatus optionally includes a flow path for the supply of a fluid to said sample chamber and a flow path for removal of said fluid from said sample chamber and may also have means for driving a flow of fluid through said sample chamber.

The apparatus may further comprise a temperature control for maintaining said fluid at a desired constant or variable temperature.

In a preferred embodiment a refractive index based measurement of a property of a fluid is measured in an apparatus comprising a variable wavelength coherent light source, a sample chamber, a wavelength controller, a light sensor, a data recorder and a computation apparatus, by

directing coherent light having a wavelength along an input light path,

producing scattering of said light from each of a plurality of interfaces within said apparatus including interfaces between said fluid and a surface bounding said fluid, said scattering producing an interference pattern formed by said scattered light,

cyclically varying the wavelength of said light in said input light path over a 1 nm to 20 nm wide range of wavelengths a rate of from 10 Hz to 50 KHz,

recording variation of intensity of the interfering light with change in wavelength of the light at an angle of observation, and
calculating a said property from said variation.

The method and the apparatus according to the invention are each broadly applicable to BSI measurements and to forward scattering measurements (FSI) and are not restricted to any one specific apparatus geometry. Thus, the sample chamber may be circular or non-circular in cross-section traversed by the light and may be a free standing tube or may be a channel in a substrate or other form of cavity. Non-circular section chambers, which may be channels, may for instance be semi-circular or rectangular in transverse section. In particular, the parts of the apparatus used other than the computation element may be as described in any of the references acknowledged herein. BSI arrangements are preferred. Sample chambers allowing a flow through of sample are preferred, e.g. channels or tubes.

Preferably, the detector is positioned to measure close to the centroid position of the interference pattern, e.g. within the first 1-30 fringes from the centroid, e.g. within the first 5-20 fringes.

Optionally, two similar sample chambers are provided in close proximity and each is similarly illuminated by a respective or common light source to provide a similar interference pattern such that one interference pattern may operate as a reference channel for the other. Thus, for instance, if the sample in one chamber is kept constant in nature and the sample in the other chamber is allowed to vary, the variations may be isolated from the effects of factors influencing both chambers such as temperature change. Where two light sources are used, they may be scanned in wavelength in synchrony.

Computation apparatus used in the methods described above or forming part of apparatus according to the invention may be programmed computation means suitably programmed for also processing the intensity variation to extract from it the desired refractive index based measurement. This may be an absolute value of refractive index. It may be a shift in refractive index consequent upon a change in the fluid. Such an absolute or relative value of refractive index may be converted to units of another parameter, such as temperature or substance concentration, by the use of a suitable calibration curve, look up table or the like by the computation apparatus.

Computation of the desired measurement from the modified intensity variation may be by FFT, cross-correlation, pattern recognition or other such known methods. Generally, all methods of analysis of an interference fringe pattern previously used in BSI based determinations may be used.

All of the apparatus features described above in connection with the method of the invention may be used in such apparatus.

Fluids may be driven through the cavity or cavities of the apparatus where desired by the action of a suitable fluid flow driving means, which may be a pump, such as a syringe pump or peristaltic pump, or may be passive capillary forces, or may be means for producing electro-osmotic flow by the application of voltage.

The apparatus may include a temperature controller for maintaining the sample in the light path at a desired temperature. This may be a Peltier or other temperature control device and preferably includes a temperature sensor operatively connected to a device for heating and/or for cooling said sample.

References to refractive index determination herein should be understood where the context permits to include absolute refractive index measurement and also relative refractive index measurements (i.e. measurements of the difference between the refractive index of one material and that of another, or temporal changes in refractive index of one material). Refractive index measurements need not be expressed in refractive index numbers but may be translated into some other quantity which affects refractive index such as sample temperature or solute concentration. Thus, through their effect on refractive index one can measure temperature, pressure, concentration and molecular interactions, thereby obtaining thermodynamic and kinetic information for specific types of molecules which may include cytokines, hormones, immunoglobulins, C-Reactive Protein, enzymatic reactions and troponin, as well as polynucleotides by way of example.

Using the method or the apparatus of the invention, one can of course study dynamically changes over time of the recorded interference pattern with a resolution given by the sweep rate of the source. The method and apparatus can be used for studying reaction kinetics, for instance of a binding reaction.

The invention will be further illustrated and explained by the description of a preferred embodiment of the invention with reference to the accompanying drawings in which:

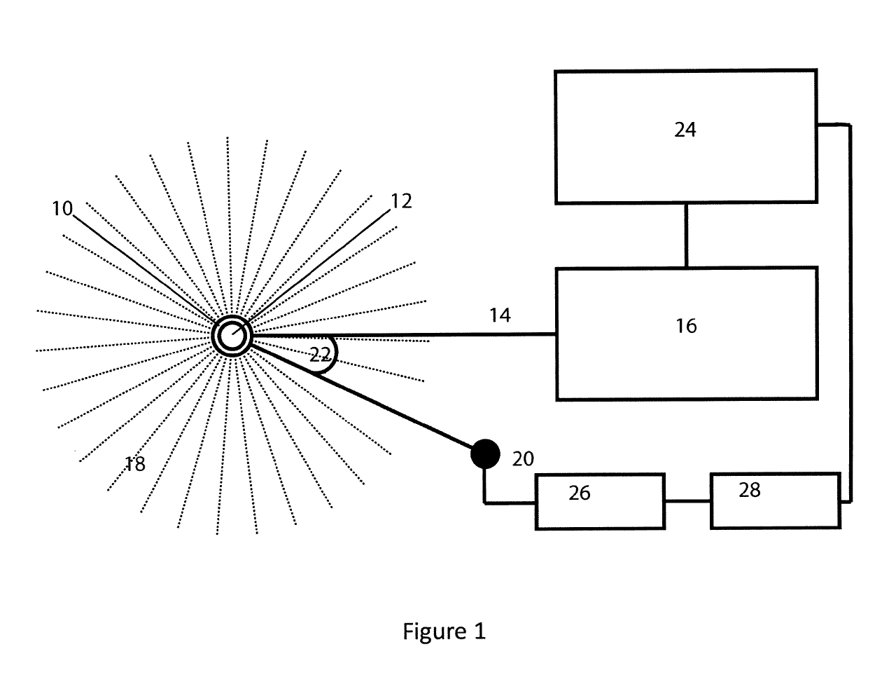

FIG. 1 shows the layout of the components of apparatus for use in the invention;

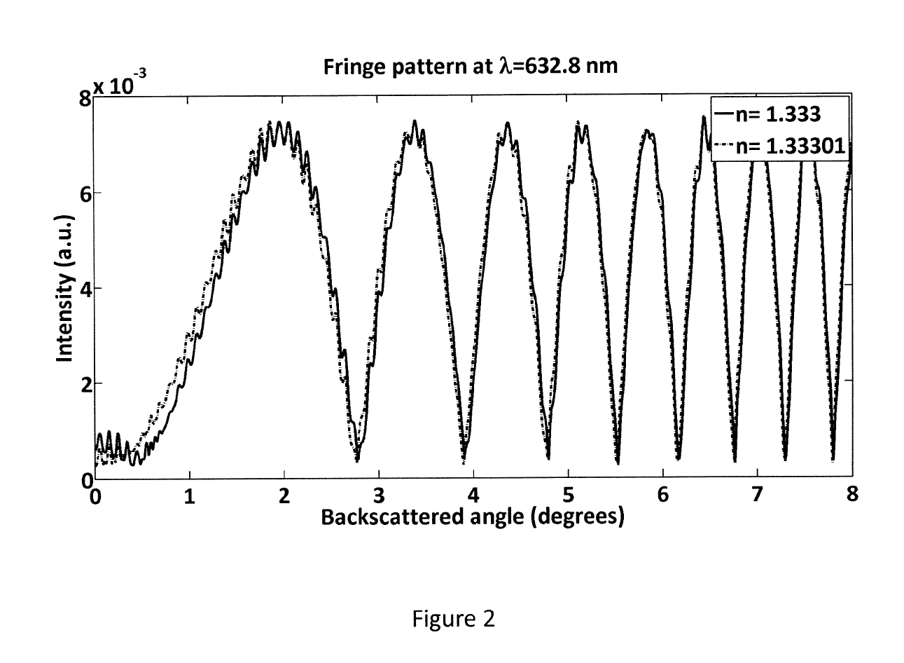

FIG. 2 shows the spatially varying intensity of light in an interference pattern produced in the apparatus of FIG. 1;

FIG. 3 shows the variation of intensity with wavelength produced in the detector of the apparatus of FIG. 1; and

FIG. 4 shows experimentally obtained results for such intensity variations in measurements on samples of glycerol water mixtures of differing concentrations.

In FIG. 1, a sample chamber 10 contains a fluid 12 on which a refractive index based measurement is to be made. A coherent light source 16 such as a laser emits a light input beam 14 which passes through the fluid 12. The sample chamber 10 and the fluid 12 present to the input beam 14 a front solid/fluid interface and a rear solid/fluid interface from which light is scattered over a range of output angles in a fan shaped area 18. A detector 20 measures the light intensity at a particular angle of observation marked at 22. By the operation of a wavelength controller 24, the wavelength of light emitted by the coherent light source 16 is swept over a range of for instance 5 nm at a sweep frequency of 16 KHz. The intensity of the light is observed at an angle 22 from the input beam and the detected intensities are recorded in a data recorder 26 and analysed in computation apparatus 28. The data recorder and the computation apparatus may suitable be combined in a computer. The wavelength controller 24 also provides the data recorder and the computation apparatus with a trigger signal for the tuning range and possibly a trigger signal for linearization of the k-values obtained over the tuning range.

At any given input wavelength, the scattered light forms an interference pattern within the area 18 which will have an intensity pattern of the kind shown in FIG. 2 when observed over a range of angles from the axis of the laser outwardly to the right hand side of the illustrated apparatus. It may be noted that the interference fringes shown are not equally spaced. The figure shows intensity curves for two different refractive indices for the fluid 12, for the cases n=1.333 and n=1.33301. It can be seen that the two curves are not readily distinguishable by position. They also have a good deal of fine structure, making the true position of each maximum difficult to identify. Thus, the fringe pattern are affected by other frequency components than the one of interest.

However, when the intensity variation with wavelength sweep is measured at a single angle of observation, a result is obtained as shown in FIG. 3, again with plots being shown for each of the two refractive index cases, n=1.333 and n=1.33301.

It is noticeable that the peaks in the illustrated plots are regularly spaced and that the peaks are less affected by other frequency components and the positions of the peaks are more clearly different for the two refractive indices.

A refractive index measurement may therefore be made by applying the usual data analysis methods employed in BSI measurements to the fringe pattern obtained by wavelength sweep.

If one records such fringe patterns as function of the inverse of the wavelength at several angular positions one could also calculate mean or median values of the individual estimates of a refractive index or refractive index change.

The interference term of interest measured with the detector as a function of the angular wavenumber k behaves like:

Intensity (I)=sin (kΔl)

Transforming this to the usual notation for a sinusoidal form, the equation becomes:

$$I = sin ( 2 π ( \frac{Δ l}{2 π} ) k )$$

where k is the running wave-number corresponding to the swept range of the source, and Δl is the optical path length difference between the two interfering beams. If the refractive index of the liquid within the sample chamber changes Δn the interference term changes to become:

$$I = sin [ k ( Δ l + Δ nL ) ] = sin [ 2 π ( \frac{Δ l + Δ nL}{2 π} ) k ]$$

where L denotes the path length through the sample chamber experienced by only one of the interfering beams. We observe that a frequency shift of ΔnL/2π is introduced.

Because Δn for BSI could typically be in the order of 10⁻⁶ and L is in the order of 1 mm, a very large k-range would be needed to resolve the difference. Instead it is useful that due to the large values of k the frequency shift can actually be observed as a phase shift φ where:

$$sin [ k ( Δ l + Δ nL ) ] = sin [ 2 π ( \frac{Δ l + Δ nL}{2 π} ) k ] = sin [ 2 π ( \frac{Δ l}{2 π} ) k + k Δ nL ] = sin [ 2 π fk + ϕ ]$$

$$with$$

$$f = \frac{Δ l}{2 π}$$

$$and$$

$$ϕ = k Δ nL .$$

If we sweep the wavelength through 40 nm from e.g. 1040 nm to 1080 nm, the k range corresponds to spanning from 6.0415e+006 m⁻¹ to 5.8178e+006 m⁻¹. With L=1 mm and Δn=1E−06 this implies the “phase” φ varies from 0.0060 to 0.0058. If Δn=0.9E−06 φ varies from 0.0054 to 0.0052.

If we sweep the wavelength through 5 nm from e.g. 1055 nm to 1060 nm, the k range corresponds to 5.96E+06 m⁻¹ to 5.93E+06 m⁻¹ implying that the “phase” φ varies from 0.0060 to 0.0059 for L=1 mm and Δn=1E−06. If Δn=0.9E−06 φ varies from 0.0054 to 0.0053

This shows the phase change due to a change of 10E−7 in refractive index of the liquid is around 0.0006 whereas the variation in phase due to the k variation is six times smaller for a sweep of 5 nm. Thus, if Δn=1E−06 then by varying k by sweeping the wavelength over 5 nm φ varies from 0.0060 to 0.0059; a change of 0.0001. If Δn=0.9E−06 the sweep over 5 nm makes φ vary from 0.0054 to 0.0053, again a change of 0.0001. But the change from the average of 0.006 to 0.0059 (the phase range measured with Δn=1E−06) to the average of 0.0054 to 0.0053 (the phase range measured with Δn=0.9E−06) is 6 times larger: 0.0006. So the variation in phase caused by the sweep over k is 6 times smaller than the overall change in phase caused by changing the refractive index by 10E−7 (the difference between Δn=1E−06 and Δn=0.9E−06). This demonstrates for this exemplified case that one can interpret the essential phase change of the fringe pattern as being caused by change in refractive index (at least down to changes of 10-7). The sweep range and geometry of the channel will in general influence these numbers. The smaller the sweep range the smaller the variation in phase due to sweep.

FIG. 3 shows experimentally obtained results measuring the variation of intensity against k for glycerol water mixtures of given glycerol concentrations. It can be seen that as the refractive index changes with concentration of glycerol, so the position of each peak in shifts to the right. Accordingly, the phase of the peaks can be used as an RI measure. The refractive index value change between e.g. the 20 mM and 30 mM concentrations is known to be 2.7*10⁻⁴RIU. The phase changes observed along the k-axis are as expected according to the calculated relationship φ=kΔnL.

In this specification, unless expressly otherwise indicated, the word ‘or’ is used in the sense of an operator that returns a true value when either or both of the stated conditions is met, as opposed to the operator ‘exclusive or’ which requires that only one of the conditions is met. The word ‘comprising’ is used in the sense of ‘including’ rather than in to mean ‘consisting of’. All prior teachings acknowledged above are hereby incorporated by reference. No acknowledgement of any prior published document herein should be taken to be an admission or representation that the teaching thereof was common general knowledge in Australia or elsewhere at the date hereof.

1. A method of refractive index based measurement of a property of a fluid comprising:
directing coherent light having a wavelength along an input light path within an apparatus,
producing scattering of said light from each of a plurality of interfaces within said apparatus including interfaces between said fluid and a surface bounding said fluid, said scattering producing an interference pattern formed by said scattered light,
varying the wavelength of said light in said input light path,
recording variation of intensity of the interfering light with change in wavelength of the light at an angle of observation, and
calculating a said property from said variation.

2. A method as claimed in claim 1, wherein said varying of the wavelength of said light sweeps the wavelength of the light over a range of wavelengths, which range is from 1 nm to 20 nm wide.

3. A method as claimed in claim 1, wherein the varying of the wavelength of the light is repeated cyclically.

4. A method as claimed in claim 3, wherein said varying of the wavelength of said light sweeps the wavelength of the light cyclically at a rate of from 10 Hz to 50 KHz.

5. Apparatus for refractive index based measurement of a property of a fluid, said apparatus comprising a variable wavelength coherent light source, a sample chamber, a wavelength controller, a light sensor, a data recorder and a computation apparatus, wherein
the variable wavelength light source is arranged for directing coherent light having a wavelength along an input light path within the apparatus,
the sample chamber is arranged in the input light path for holding a fluid sample and for producing scattering in use of said light from each of a plurality of interfaces within said sample chamber including interfaces between said fluid and a surface bounding said fluid, said scattering producing an interference pattern formed by said scattered light,
the wavelength controller is operable for varying the wavelength of said light in said input light path,
the light sensor is positioned and operatively connected to the data recorder for sensing and recording variation of intensity of the interfering light with change in wavelength of the light at an angle of observation, and
the computation apparatus is programmed for calculating a said property from said variation.

6. Apparatus as claimed in claim 5, wherein the said sample chamber for containing said fluid has a transverse dimension in the direction of the input light path of from 1 μm to 10 mm.

7. Apparatus as claimed in claim 6, wherein the said sample chamber for containing said fluid has a transverse dimension in the direction of the input light path of from 0.5 to 3 mm.

8. Apparatus as claimed in claim 5, wherein said apparatus includes a flow path for the supply of a fluid to said sample chamber and a flow path for removal of said fluid from said sample chamber.

9. Apparatus as claimed in claim 8, further comprising means for driving a flow of fluid through said sample chamber.

10. Apparatus as claimed in claim 5, further comprising a temperature control for maintaining said fluid at a desired constant or variable temperature.
